(19) United States
(12) Patent Application Publication
(10) Pub. No.: US 2024/0378666 A1
(43) Pub. Date: Nov. 14, 2024

(54) SYSTEM AND METHODS FOR AUTOMATED LOAN ORIGINATION DATA VALIDATION AND LOAN RISK BIAS PREDICTION

(71) Applicant: TRAiNED, Pittsburgh, PA (US)

(72) Inventors: Jonathan Freed, Bridgeville, PA (US); David John Paulina, JR., McMurray, PA (US); Kyle Scott W. Jenkins, New Kensington, PA (US); George Salvatore Goehring, Coraopolis, PA (US); Nicholas J. Goossen, Moon Township, PA (US); Joseph Arthur Friedman, Pittsburgh, PA (US); Jason Scott Overand, Pittsburgh, PA (US); Christina Soukhamneut, Savannah, GA (US); Janet Louise Wilson, Morton, PA (US); Jennifer Ann Auvinen, Winnemucca, NV (US)

(21) Appl. No.: 18/337,350

(22) Filed: Jun. 19, 2023

Related U.S. Application Data
(60) Provisional application No. 63/501,658, filed on May 11, 2023.

(51) Int. Cl. G06Q 40/03

(52) U.S. Cl. CPC G06Q 40/03

(57) ABSTRACT

A platform which provides a system and method for loan origination data validation and predictive analysis comprising a user interface which allows platform users to upload data, a data acquisition engine that leverages one or more machine and/or deep learning algorithms to classify, validate, and enforce compliance of the uploaded data, and an artificial intelligence engine that constructs and maintains the models developed from the machine and/or deep learning algorithms. The platform may utilize various bespoke APIs to integrate validated data with lender institution loan origination systems when a lender initiates the process. The platform can function as a system of record and central, secure repository for a borrower's documentation and information required to apply for a loan. In some embodiments, the platform utilizes a trained generative AI model to assist platform users and to provide predictive analysis responsive to user submitted queries.

### CROSS REFERENCE TO RELATED APPLICATIONS

Priority is claimed in the application data sheet to the following patents or patent applications, each of which is expressly incorporated herein by reference in its entirety:
63/501,658

### BACKGROUND OF THE INVENTION

### Field of the Art

The present invention is in the field of loan origination, and more particularly in the field of risk bias management.

### Discussion of the State of the Art

Financial institutions that service loans (i.e., lenders) may utilize a loan origination system (LOS) which acts as a repository for any documentation and information that is required for a borrower to apply for a loan. Each lender may operate different LOS each with its own formatting protocols. A borrower must upload a large plurality of documentation including personal information, financial information, demographic information, and more to a lender when applying for a loan. A prudent borrower will shop at multiple lenders to acquire the best loan terms he or she can. Currently, a borrower must provide all the documentation repeatedly for each lender the borrower chooses to conduct business with. This is exasperating to the customer at best and is time consuming for each lender to have to validate each document and the information contained therein. Furthermore, lenders may possess some hidden risk bias that can adversely affect certain borrowers based on demographic data, location data, or other information.

What is needed is a system and method for automated loan origination data validation and loan risk bias prediction which overcomes the limitations of the existing art.

### SUMMARY OF THE INVENTION

Accordingly, the inventor has conceived and reduced to practice, a platform which provides a system and method for loan origination data validation and predictive analysis comprising a user interface which allows platform users to upload data, a data acquisition engine that leverages one or more machine and/or deep learning algorithms to classify, validate, and enforce compliance of the uploaded data, and an artificial intelligence engine that constructs and maintains the models developed from the machine and/or deep learning algorithms. The platform may utilize various bespoke APIs to integrate validated data with lender institution loan origination systems when a lender initiates the process. The platform can function as a system of record and central, secure repository for a borrower's documentation and information required to apply for a loan. In some embodiments, the platform utilizes a trained generative AI model to assist platform users and to provide predictive analysis responsive to user submitted queries.

According to a preferred embodiment, a system for loan origination data validation and predictive analysis is disclosed, comprising: a computing device comprising a memory and a processor; a data acquisition engine comprising a first plurality of programming instructions stored in the memory which, when operating on the processor, causes the computing device to: receive one or more documents associated with a borrower; feed the one or more documents into a first machine learning model configured to assign a classification to each of the one or more documents; feed each of the one or more documents and its classification into a second machine learning model configured to validate the data; and store the validated data in a borrower profile; and a generative artificial intelligence model configured to receive as input query and the borrower profile and generate predictive responses to the query.

According to another preferred embodiment, a method loan origination data validation and predictive analysis is disclosed, comprising the steps of: receiving one or more documents associated with a borrower; feeding the one or more documents into a first machine learning model configured to assign a classification to each of the one or more documents; feeding each of the one or more documents and its classification into a second machine learning model configured to validate the data; storing the validated data in a borrower profile; and using a generative artificial intelligence model configured to receive as input query and the borrower profile to generate predictive responses to the query.

According to an aspect of an embodiment, the first machine learning model is a trained classifier network.

According to an aspect of an embodiment, the second machine learning model is trained using a regression algorithm.

According to an aspect of an embodiment, the data acquisition engine is further configured to: retrieve one or more compliance rules; and transform the validated data to enforce compliance with the one or more compliance rules.

According to an aspect of an embodiment, the borrower profile comprise one or more access rules define one or more lender institutions which the borrower has authorized to the data in the borrower profile.

According to an aspect of an embodiment, an application programming interface comprising a second plurality of programming instructions stored in the memory which, when operating on the processor, causes the computing device to: transmit the validated data in the borrower profile to a loan origination system associated with the one or more authorized lender institutions.

### BRIEF DESCRIPTION OF THE DRAWING FIGURES

FIG. 1 is a block diagram illustrating an exemplary system architecture for a loan origination data validation and risk bias prediction platform, according to one aspect.

FIG. 2 is a block diagram illustrating an exemplary data that may be stored in one or more databases, according to an embodiment.

FIG. 3 is a block diagram illustrating an exemplary aspect of a platform for loan origination data validation and predictive analysis, a data acquisition engine.

FIG. 4 is a block diagram illustrating an exemplary aspect of a platform for loan origination data validation and predictive analysis, an artificial intelligence engine.

FIG. 5 is a flow diagram illustrating an exemplary method for training a document classifier network, according to an embodiment.

FIG. 6 is a flow diagram illustrating an exemplary method for training a machine learning regression algorithm to make predictions related to risk bias, according to an embodiment.

FIG. 7 is a flow diagram illustrating an exemplary process for implementing rules-based text and data validation model, according to an embodiment.

FIG. 8 is a flow diagram illustrating an exemplary method for processing uploaded data into user profiles, according to one aspect.

FIG. 9 is a flow diagram illustrating an exemplary method for generating prediction associated with loan origination utilizing generative AI, according to one aspect.

FIG. 10 is a block diagram illustrating an exemplary hardware architecture of a computing device.

FIG. 11 is a block diagram illustrating an exemplary logical architecture for a client device.

FIG. 12 is a block diagram showing an exemplary architectural arrangement of clients, servers, and external services.

FIG. 13 is another block diagram illustrating an exemplary hardware architecture of a computing device.

### DETAILED DESCRIPTION OF THE DRAWING FIGURES

The inventor has conceived, and reduced to practice, a platform which provides a system and method for loan origination data validation and predictive analysis comprising a user interface which allows platform users to upload data, a data acquisition engine that leverages one or more machine and/or deep learning algorithms to classify, validate, and enforce compliance of the uploaded data, and an artificial intelligence engine that constructs and maintains the models developed from the machine and/or deep learning algorithms. The platform may utilize various bespoke APIs to integrate validated data with lender institution loan origination systems when a lender initiates the process. The platform can function as a system of record and central, secure repository for a borrower's documentation and information required to apply for a loan. In some embodiments, the platform utilizes a trained generative AI model to assist platform users and to provide predictive analysis responsive to user submitted queries.

The system and methods discussed herein can provide automated processes enhanced with artificial intelligence to improve the user experience by providing a secure data repository with respect to mortgage origination. In a particular use case, either a lender or a borrower can provide the platform with the requisite documents and information necessary to originate a loan, wherein the platform provides, among other functions, automated data validation, compliance, and normalization of the provided information before the data is securely stored in a one or more databases and associated with the borrower. At this point, the platform has a repository of validated and compliant data which can be provided (with borrower consent) to one or more loan origination systems (LOS) associated with a mortgage company such as a bank or other type of lender using one or more bespoke APIs provided by the platform. Currently, each lender may use their own LOS and may require the borrower to submit the requisite documents and information necessary to start a loan application. The borrower must submit all this information to each different lender the borrower applies with. What's more, each different lender must also individually validate the borrower's information. The disclosed system provides utility to both borrowers and lenders because it allows borrowers/lenders to only have to upload the required documents and information only once and further provides borrowers with the control over who can receive that information, Lenders can benefit from the automated document and information validation and compliance and the easy integration of such information into their existing LOS via integrated APIs.

Furthermore, the platform leverages big data and machine learning to provide insight and analysis of data related to loans, borrowers, and lenders. In some implementations, a generative artificial intelligence model may be developed to provide analysis and assist users.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any particular order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “lender” or “system user” as referred to herein represents any individual, group (public or private), or a financial institution which provides loan services directly to consumers. Lenders provide funds for a variety of reasons, such as a home mortgage, an automobile loan, or a small business loan.

The term “borrower” to herein represents an individual who accesses the platform to provide documentation and information associated with a loan application. Borrower's may interface with the platform to provide authentication and/or authorization when applicable.

### Conceptual Architecture

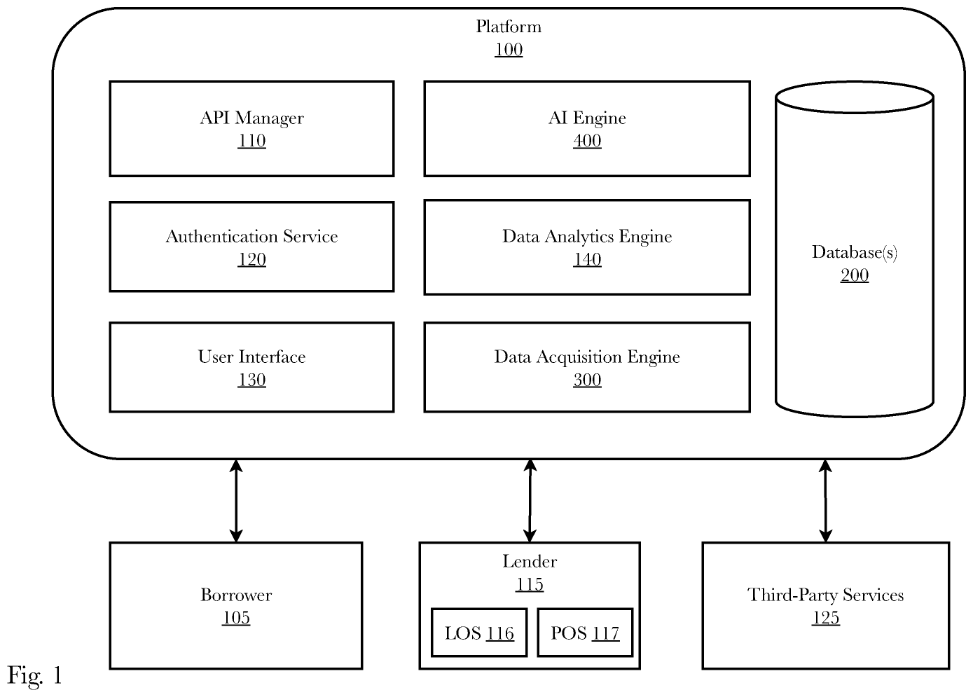

FIG. 1 is a block diagram illustrating an exemplary system architecture for a loan origination data validation and risk bias prediction platform 100, according to one aspect. According to various embodiments, platform 100 can be configured to receive a plurality of information associated with a platform user and provide automated data validation, data compliance, and data transformations on any received data, and which maintains data security and generates alerts to the platform user and/or enterprise. The platform can obtain data from users and/or directly from third-party services, and in some embodiments uses a generational artificial intelligence (AI) system configured to drive digital questions and technical interaction with the platform user based on the obtained information and provide insight and analysis, according to some embodiments. The AI may ask questions based on the obtained data, wherein the questions require documents to be gathered and uploaded or downloaded from third-party services. During the validation process data may be flagged that cannot be validated or may not be compliant with existing rules, and the AI may ask the user for more information or give suggestions to the user on how to address the flagged data in order for the data to be validated and/or verified compliant. Furthermore, in certain embodiments the generative AI model may be capable of generating media associated with loan application processing. For example, according to one embodiment, the generative AI may be used to generate potential mortgage offers based on input data and the underlying model. In such an embodiment, a borrower or lender may be able to upload to platform 100 whatever documentation and information they may currently possess and which is associated with information necessary to apply for a loan and the generative AI can generate an individually tailored mortgage loan estimate (e.g., including loan terms such as length, interest rate, amortization schedule, and/or the like) for the borrower using on the data provided. In some implementations, the generative AI may be configured to predict risk bias associated with a borrower and/or lender.

According to the embodiment, a platform can provide utility to borrowers who are preparing to secure a loan from a lender. The borrower may or may not be aware of the required documentation and information necessary to apply for a home loan. The borrower may already be in possession of all, a portion of, or none of the required documentation and information necessary to apply for a home loan. The borrower can access platform 100 via user interface 130 using a computing device of the borrower's own choosing and personal preference. For example, the borrower can access platform 100 using a mobile application stored and operating on his or her smart phone, or via a web application or website via an Internet connection, and/or the like.

Once the borrower has accessed platform 100 via UI 130 they may upload any of the required documents (e.g., pay stubs, W-2s, etc.) and information (e.g., contact information, credit report, etc.). Data uploaded to platform 100 by the borrower may be sent to a data acquisition engine 300 which can be configured to validate the borrower's data, verify the uploaded data is in compliance with various regulations and rules, and transform the data as necessary. In some implementations, data acquisition engine 300 may leverage one or more machine learning algorithms and/or models to facilitate one or more data validation processes. For example, a trained classifier network may be used to analyze and classify obtained documents. Once a document has been classified, data acquisition engine 300 can perform validation by scanning the document to identify certain data fields, determining if the data fields contain valid data, if the data is not valid generating an alert signal which can be communicated back to the borrower, loan origination system (LOS) 116, and/or point-of-sale (POS) 117, and securely storing the document in a database 200 when the entire document has been scanned. POS 117 may communicate and transmit data with platform 100 via APIs and/or via user interface 130. POS data may be sent to platform and validated and stored as described herein. Additionally, or alternatively, platform may communicate with lenders via the website/web app UI and/or standard messaging with a checklist, report, and summary statement. The UI 130 may display a message to the borrower informing the borrower that a document has been successfully upload and validated. The UI 130 may display a message to the borrower informing the borrower that a document has not been fully validated and the message may include more information such as, for example, the name of the document which could not be fully validated, the data fields which could not be validated, and in some embodiments, recommended corrections or suggestions of resources which the borrower can use to correct the unvalidated data. In some implementations, a process may be configured to handle invalid data: the platform identifies invalid data and informs the borrower/lender via the UI where the borrower/lender is allowed to correct the data, and then the platform publishes the updated data onto the appropriate LOS or intended recipient platform.

In some embodiments, data may be extracted from a borrower's document and transformed for data storage or data transmission. Platform is configured to receive documents of data in various formats including, but not limited to, comma separated variable (CSV), json, xml, pdf, doc, docx, html, htm, xls, and xlsx, to name a few. For example, as a document is being scanned and each validated data field and its associated data may be extracted and transformed into a comma-separated-variable (.CSV) file, encrypted, and then stored in database 200. In some implementations, data may be transformed based on business rules or logic associated with an enterprise. An enterprise may refer to a financial lender (e.g., a bank, a mortgage lender, etc.) or a to a financial lender's loan origination system (LOS). In this way, data may be transformed into a format that is easily transmittable and ready to efficiently integrate with enterprise systems and software based on business rules and logic set forth by the enterprise itself. For example, an enterprise rule may require that all names be all upper case lettering, or that numerical values must be represented as a double to the one-hundredth decimal, or that data must be encrypted according to a specific protocol, and/or the like. Furthermore, obtained data may be further checked for compliance with governmental rules and regulations such as, for example, the European general data protection regulation (GDPR) or the California Consumer Privacy Act (CCPA). Data acquisition engine 300 can verify that borrower data, which can include sensitive information such as personal identifying information (PII) or personal health information (PHI), is being processed and stored in compliance with all rules and regulations.

According to various embodiments, data acquisition engine 300 may validate data using machine learning. In one embodiment, a machine learning algorithm may be trained to produce a model that can perform data validation and assign a confidence score to the analyzed data, wherein the confidence score may be used to determine if the analyzed data is valid or not. Validation rules may be established and used when performing data validation. For example a validation rule for a document may state that the beginning balance plus/minus deposit/debit values should then calculate to the ending balance, or that pay stubs balance out, and/or the like. The confidence score may be a numerical value such as a number between 0 and 100 or any other arbitrary number range. Alternatively, or additionally, a confidence score could be represented using a color scheme such as green for high confidence that the data is valid, yellow for average confidence indicating that the borrower and/or lender should review the submitted information, and red for low confidence indicating and flagged for review.

In some implementations, platform may be configured to send validated data to a LOS associated with a lender via one or more application programming interfaces (APIs) which facilitate data exchange between enterprise LOS and platform. An API manager 110 may be present and configured to manage the execution and maintenance of a plurality of bespoke APIs. In some implementation's an API may be associated with a specific type of LOS or other enterprise software.

According to some embodiments, database(s) 200 may comprise one or more non-volatile data storage devices. Database(s) 200 may comprise one or more of the following systems, but is not limited to such systems, a centralized database, a distributed database, a NoSQL database, a cloud database, a relational database, a non-relational database, an object oriented database, hierarchical database, etc.

In some embodiments, data acquisition engine 300 may perform data encryption on obtained data prior to any validation, compliance, storage, or transformation actions occur. For example, platform 100 may utilize advanced encryption standard (AES) which uses “symmetric” key encryption and is well known to those with skill in the art. Furthermore, platform 100 may utilize one or more authentication schemes or mechanisms 120 for providing access to borrowers and lenders alike. For example, two-factor authentication (2FA) or two-step verification may be implemented in some embodiments to provide user verification and grant access to platform.

In some implementations, platform 100 may obtain data from one or more third-party sources 125. The obtained third-party data may be used as input into the generational AI and/or it may be validated and transformed, if applicable. For example, platform 100 may obtain data directly from the Internal Revenue Service (IRS) such as a borrower's W-2 and tax filing information. Furthermore, platform 100 may interface with United States government backed institutions such as Federal National Mortgage Association (FNMA) and/or Federal Home Loan Mortgage Corporation (Freddie) and provide them with the borrower's validated documents. In some implementations, platform may connect with Desktop Underwriter (FNMA) and/or Loan Processor (Freddie) to automatically upload validated documents.

The system may comprise a data acquisition engine 300 configured to receive data obtained from a borrower 105, a lender 115, and/or third-party services 125. The data acquisition engine 300 may receive data from the user interface 130, from API manager 110, and in some instances, directly from various third-party services and sources 125. Data acquisition engine 300 may receive borrower information and documents associated with applying for a loan. Some of the information and documents that may be obtained by platform 100 can include, but is not limited to, personal information (e.g., name, social security number, date of birth, address, phone number, email address, health information, etc.), employment and income information (e.g., current and previous employers, length of employment, and income documentation such as pay stubs, W-2s, and tax returns), assets and liabilities (e.g., bank statements, investment account statements, and information about any outstanding debts, etc.), credit history (e.g., credit score, credit reports, and information about any bankruptcies, foreclosures, and other credit issues, etc.), and property information (e.g., the address and purchase price of the home of interest, as well as information about any other real estate the borrower owns). Data acquisition engine 300 may utilize one or more machine learning algorithms to automatically validate obtained data as well as enforce compliance rules, best practices, guidelines, overlays, etc., if applicable, and provide data normalization.

The system may comprise an application programming interface (API) manager 110 configured to manage the deployment and maintenance of a plurality of bespoke APIs configured to integrate platform 100 with external third-party services 125, and/or a loan origination system (LOS) 116. API manager 110 is configured to control the ways in which the plurality of APIs are used within the platform 100 and by external systems. In some implementations, API manager 110 plays a part in designing, deploying, managing, and retiring APIs. The plurality of APIs can enable applications to communicate with each other and exchange information. They act as a gateway between applications and services, offering a set of defined rules which allow applications to communicate to each and share information. As a result, the APIs managed via API manager 110 make it easier for platform 100 to provide an interface with services and leverage third-party solutions where applicable. API manager 110 provides scalability and manages API integrations across an increasing number of systems and applications, whether they are on-premises, on the cloud, hybrid cloud, or multi-cloud. API manager 110 may deploy and reuse integration assets quickly, securely, and efficiently.

The platform 100 may comprise a user interface (UI) 130 which can provide a front-end user experience and interface for providing information and interacting with platform services. The UI 130 can provide a means for receiving user input (e.g., identification data, financial data, etc.) and displaying system output (e.g., system request for information, etc.). The output may be responsive to a user query or action, or based on an action or internal process of one or more platform services and/or components. In some implementations, the UI 130 is a graphical user interface (GUI). In some implementations, the UI 130 is a web-application accessible via an Internet connection on a suitable computing device (e.g., desktop computer, laptop, tablet computer, smart wearable, smart phone, etc.). In some implementations, the UI 130 is a software application operating on a borrower's mobile computing device such as, for example, a borrower's smart phone. The UI 130 may interact with other platform services and/or components. For example, UI 130 may communicate with data services 130 in order to retrieve information related to a submitted request. Further, the UI 130 can be integrated with a generative AI model that functions as both a platform assistant and data gathering component integrated with data acquisition engine 300.

According to the embodiment, platform 100 may comprise a data analytics engine 140 configured to perform various analysis on data obtained by platform 100. In some implementations, the data analysis leverages one or more machine and/or deep learning models to make predictions related to loan origination and/or servicing. According to some embodiments, data analytics engine 140 implements a risk bias model to make predictions about potential risk bias in loans offered by lenders to borrowers. Yet in other embodiments, data analytics engine 140 may leverage a generative AI model trained on multi-modality data such as, for example, data stored in database(s) 200 including natural language text, code (i.e., programming language text), and/or images (e.g., images of documents associated with loan origination), to respond to user queries and provide generated output based on the user query, input data, and the large corpus of multi-modality data used to train the model.

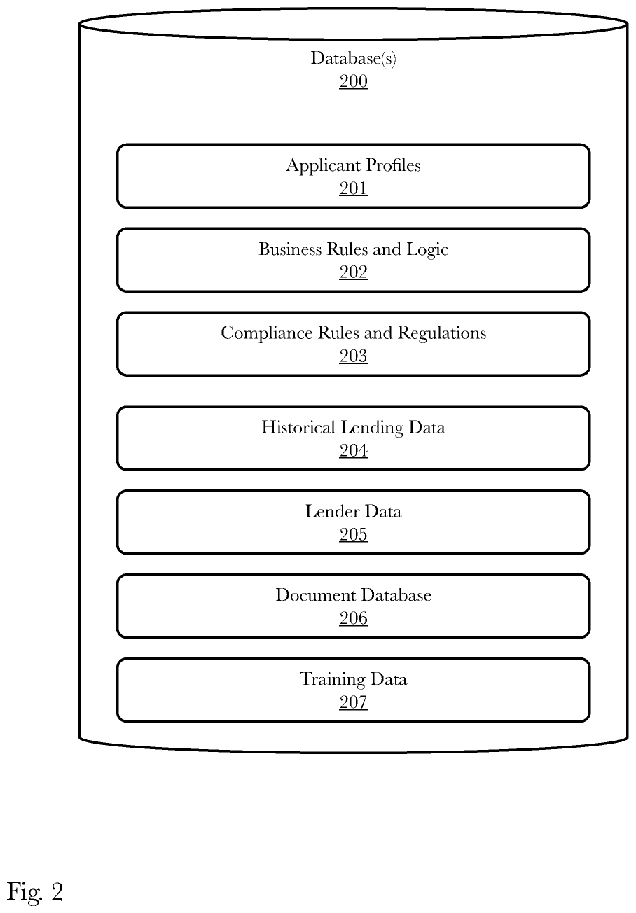

FIG. 2 is a block diagram illustrating an exemplary data 201-207 that may be stored in one or more databases 200, according to an embodiment. According to the embodiment, database(s) 200 may comprise a plurality of information including, but not limited to, a plurality of borrower profiles 201, various business rules and logic 202, compliance rule and regulations 203, historical lending data 204, lender specific data 205, document data 206, and training data 207. Database(s) 200 may also store obtained platform user behavior and interactions such as, for example, clicks, time spent in the system, type of browser used to access the platform, approximate geo-location data, etc. User behavior and interaction data can be used to evaluate platform performance and use. Database(s) 200 may comprise a relational database or a non-relational database or both. Database(s) 200 may comprise one or more non-volatile data storage devices such as, for example, hard drives or thumb drives. The one or more data storage devices may be disposed at a single location. The one or more data storage devices may be distributed over multiple different geographic locations. A single data storage device may comprise various types of databases (e.g., relational, NoSQL, etc.) wherein each type of database may be implemented on a single data storage device. All data stored in database(s) 200 may comply with all local data storage laws and regulation. Information stored in database(s) 200 may or may not be encrypted, dependent upon the embodiment, and further dependent upon the type of data. For example, publicly available data such as lender addresses and phone numbers need not be stored as an encrypted value in database(s) 200, whereas personal identifying information (PII) or PHI will always be encrypted when being stored and during data processing and analysis operations. In some implementations, database(s) 200 can be separated in unique, segregated repositories or hybrid containers to meet client security requirements or other needs.

According to the embodiment, database 200 comprises one or more borrower profiles 201. Each borrower profile is associated with a specific borrower and configured to store all obtained documents and information associated with the specific borrower. A borrower may be prompted to create a profile during the borrower's initial interaction with platform 100 via UI 130. In some implementations, the generative AI may assist or otherwise guide the borrower during the creation of his or her profile such as, for example, by requesting of the borrower the necessary information and walking the borrower through each step. Borrower profile data 201 may comprise information that is obtained via borrower/lender submission, sourced directly from third-party services 125 (e.g., from the IRS, etc.), and from the lender 115 via API manager 110. Borrower data may include, but is not limited to, personal information (e.g., name, social security number, date of birth, and contact information), employment and income information (e.g., current and previous employers, length of employment, and income documentation such as pay stubs, W-2s, and tax returns), assets and liabilities (e.g., bank statements, investment account statements, and information about any outstanding debts, etc.), credit history, (e.g., credit score, credit reports, and information about any bankruptcies, foreclosures, or other credit issues), and property information, and/or the like. Borrower profiles may comprise user-defined rules that govern how their data is shared and how data security is implemented. This information may be uploaded by the borrower via UI 130. For example, a borrower can scan her pay stubs or take photos of them on her smart phone and upload the photos or scanned images via UI 130 directly to platform 100. In some implementations, the documents may be uploaded as various file types including, but not limited to, .docx, .doc, .CSV, .pdf, .jpeg, .txt, etc., and need not be in a specific file type. In some implementations, platform 100 may perform a file type conversion as part of the data acquisition process in order to convert obtained data into a standard file type for system processing and analysis.

The borrower profile 201 may act as a repository for validated borrower data and acts as a system of record for the borrower thereby providing utility to the borrower because now they have can have all their required documents and information automatically validated and securely stored until they are ready to shop for home loans. A borrower can get in touch with a lender to begin the loan application process, wherein the lender 115 can initiate the process on their LOS 116, and platform 100 can transmit the borrower's profile data to any lender using the APIs. The data is tied directly to the borrower, so the borrower's data can go directly to a second or more borrower authorized lender without the need for the borrower to submit each and every document and data to each lender individually.

According to the embodiment, database 200 comprises one or more business rules and/or logic 202 which can be used to enforce data compliance with lender systems (e.g., LOS 116) as well as to configure data transformation functions. As each lender may use different LOS platforms, each lender may also have different rules for how data is input or integrated with their platforms. A lender can submit their own rules and logic that can be applied to obtained data during the data acquisition stage or during an API call on the data. For example, a lender has business rules dictate that certain data fields be formatted in upper case lettering and so, platform 100 may format the data according to the rule prior to transmitting the data via API to the lender's LOS such that when the data is easily able to integrate with the lender's LOS.

According to the embodiment, database 200 comprises one or more compliance rules and regulations 203 which may be used to verify and enforce compliance with governmental laws and regulations regarding the storage, transmission, and processing of borrower data. Compliance rules and regulations may be associated with CPPA, GDPR, or other local or governing regulations and comply with standards outlined therein when applicable.

According to the embodiment, database 200 comprises historical lending data 204. The historical lending data may comprise information from lender institutions, governmental agencies, and from borrowers. Lender institutions such as banks and mortgage lenders can provide historical lender data such as, for example, loan duration, number of loans given out, number of loans applied for, number of loans denied, reasons for loan denial, interest rates, terms, fees, down payments, closing costs, and/or the like. Borrowers can also provide this information, for example, when a borrower applies receives a loan from a lender they can upload the loan terms and data which can be saved to their profile 201 and as historical lending data 204. This information can be provided by lenders via APIs. Historical lender data can also be sourced from third-party sources 125 and publicly available databases. For example, information reported under the Home Mortgage Disclosure Act (HMDA) from over 4,300 U.S. financial institutions may be obtained by platform 100 via data acquisition engine 300 and leveraged by one or more machine learning algorithms to assess potential fair lending risks and for other purposes. HMDA data is useful as an input into platform 100 because it includes a total of 48 data points providing information about borrowers, the property securing the loan or proposed to secure the loan in the case of non-originated applications, the transaction, and identifiers. A complete list of HMDA data points and the associated data fields can be found on the website affiliated with the FFEIC. HMDA data, lender data, borrower data, and risk factors can be used as input into a trained model to evaluate an institution's fair lending risk and other lending biases that may be present and discernable by leveraging big data analysis.

According to the embodiment, database 200 comprises a plurality of lender data 205 for a plurality of various lenders. Lender data 205 may comprise data specific to a particular lender such as, for example, an address, routing information, operating hours, affiliated web address, employee information, etc. Additionally, lender data 205 may comprise lender institution metrics including, but not limited to, earning asset yield, cost of funds, net interest margin, average earning assets, average interest bearing liabilities, non-interest income/total revenue, non-performing loans, coverage of non-performing loans, and/or the like. In some implementations, lender data 205 may be used as an input into one or more machine learning algorithms configured to make predictions associated with a loan application or associated process. In some implementations, a lender may create a lender profile, similar in function to borrower profile 201, which can store the available lender data 205.

According to the embodiment, database 200 comprises a plurality of information on various types of documents related to a loan application forming a document database 206. Exemplary documents can include but are not limited to: tax return documentation; pay stubs, W-2s, or other proof income documentation; bank statement and other assets; credit history documentation; gift letters; photo identification; and renting history documentation. Documents related to tax returns (e.g., Form 4506-T) are often needed for the loan origination process to proceed and can oftentimes be directly acquired by platform directly from the IRS when applicable. Generally, two years of tax return information is necessary for loan application purposes. While tax returns may provide an overall idea of a borrower's overall financial health, pay stubs provide current earnings. Documents can further include 1099 forms and other tax documentation. Asset documentation can include investment assets as well as insurance, such as life insurance which may all come with their own form of documentation. In some implementations, when document is uploaded it may be scanned and classified in order to create an indexable repository of documents from various institutions. The document database 206 may relate scanned and classified documents with a particular institution thereby creating a logical link between identifiable documentation and the institution it originated from. A document library can be leveraged to train a classifier network to identify input documents using labeled datasets of documents, their institution of origination, and key words or features associated with a particular document. For example, most W-2 forms are easily identifiable and have common data fields (e.g., “employee name, address, and ZIP code, “wages, tips, and other compensation”, etc.) which are generally present in various formats of the W-2, whereas pay stub documentation can vary greatly in design and layout, but may contain similar identifiable data fields (e.g., “employee name”, “pay period”, “income”, “rate”, “hours”, “deductions”, “net pay”, etc.). The classifier network may be configured to compare relative documents to each other the learn from experience and then auto-approve documents based on the comparison. For example, the classifier may identify extracted data fields or tags generally associated with pay stubs and can classify the document as a pay stub based on confidence score which indicates the classifier's confidence value that a given document is accurately identified as a particular document such as, for example, a pay stub.

According to the embodiment, database 200 further comprises a plurality of training data 207. The data stored in database 200 may be drawn from to create training and test datasets for training and testing one or more machine and/or deep learning algorithms. These curated training and/or test datasets 207 may be stored in database 200 as a form of data provenance in case there is a need to perform a data audit and for model training and refinement tasks over time. AI engine 400 may retrieve a plurality of data from database(s) 200 and create training datasets as necessary for the training of various machine and/or deep learning algorithms such as, for example, classifier networks, data validation algorithms, and/or a generational AI system.

It should be appreciated that the information 201-207 illustrated herein is only exemplary and does not represent the full extent nor does it limit in any way the types of data and/or the sources from which said data may be obtained. In some implementations, the information obtained by platform 100 and stored in database(s) 200 can include, but is not limited to, borrower and business surveys, online tracking, transactional data tracking, online marketing analytics, social media monitoring data, collecting subscription and registration data, borrower mobile device data and metadata, etc.

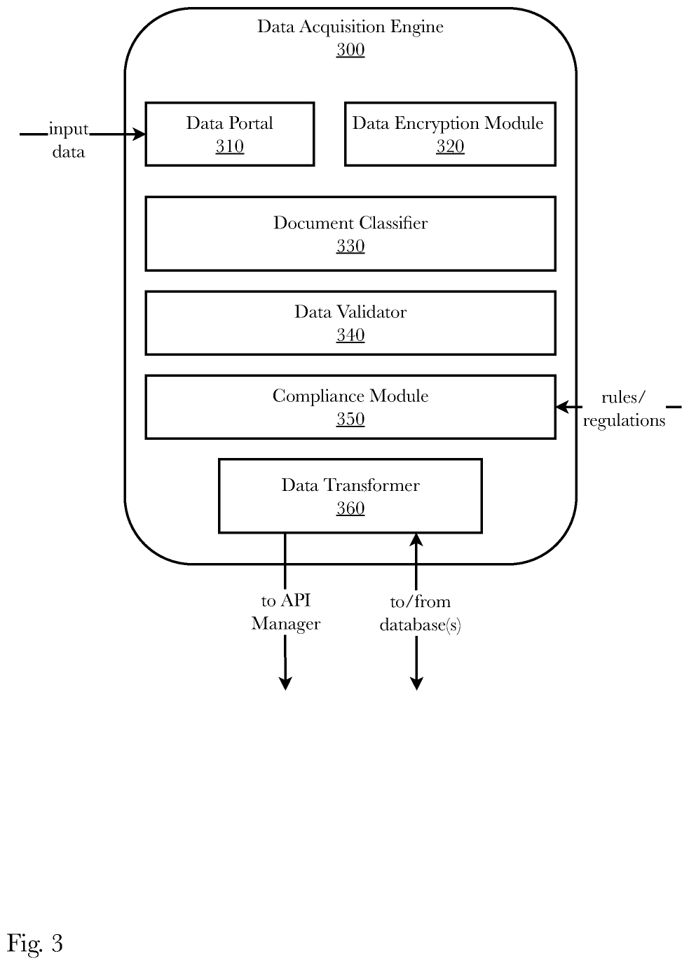

FIG. 3 is a block diagram illustrating an exemplary aspect of a platform for loan origination data validation and predictive analysis, a data acquisition engine 300. According to the embodiment, data acquisition engine (DAE) 300 may comprise a data portal 310 which acts as a gateway to receive a plurality of data from various sources such as, for example, user input received via UI 130, data received via API by way of API manager 110, and data directly received from third-party services 125. In some implementations, data portal 310 may be configured to perform an initial security check on the received data before the data is further processed by DAE 300. For example, the file size of received data may be checked and compared to historical file size values for similar data. Continuing the example, if a borrower is uploading a standard word processing document with text and normal formatting, then data portal 310 would expect a file size to be in the range of 10-500 KB, and if a file size of 1 MB or more is detected, then the current data would be flagged, and an alert can be generated and communicated to the user via UI 130. Data portal 310 may also be configured to check if the received data is encrypted, and if the data is not encrypted then a data encryption module 320 may encrypt the data according to one or more various types of encryption methods known to those with skill in the art. An exemplary encryption algorithm that may be implemented by data encryption module 320 is the advanced encryption standard which is a symmetric block cipher which decrypts data in blocks of 128 bits using cryptographic keys of 128, 192, or 256 bits. Other embodiments may utilize the RSA public-key signature algorithm which uses logarithmic functions (e.g., hash functions) to encrypt the data.

According to the embodiment, data acquisition engine 300 may comprise a document classifier 330 and/or data validator 340 which may each leverage one or more machine and/or deep learning algorithms to perform document classification tasks and data validation tasks on received data. Document classifier 330 may utilize a trained classifier network configured to classify input data as one of a plurality of “known” or “learned” documents. In a use case, document classifier 330 receives one or more documents uploaded to platform 100 by a borrower (or a lender) who is preparing to shop for home loans, and classifies the uploaded documents based on identified key words and/or identified data features. For example, an uploaded document may be scanned (e.g., optical character recognition, etc.) and the data fields extracted and analyzed by a classifier network configured to output a predicted document type based on the analysis of the extracted data fields. The output of the classifier network can be used to identify the uploaded document. The identity of the document can be used by data validator 340 which can check each of the extracted data fields to check the validity of the data and assigning a confidence score to each data field, wherein the confidence score indicates a confidence that a given data fields contains valid data. In some embodiments, a trained regression model may be utilized which receives input data fields and an indication of the type of document the data fields are associated with, and outputs a confidence score indicating whether the data is valid, or should be flagged for review by a human (e.g., lender). Flagged data may be communicated back to the system user via UI 130 or sent to a lender 115 via API manager 110.

In various implementations, any of DAE 300 components 330-350 may utilize, in conjunction with machine learning, computer vision, OCR, natural language processing, and other techniques.

According to the embodiment, data acquisition engine 300 may also comprise a compliance module 350 configured to enforce compliance with any business rules and logic as well as any governmental rules and regulations which may apply to the data being processed. Compliance module 350 may retrieve a plurality of rules, regulations, and logic from database(s) 200 and apply these to the data. A data transformer 360 may be used to transform the data to comply with any rules or regulations. For example, a business rule may indicate that a certain data field must have a specific number of significant figures and data transformer 360 can transform the data so that it contains the correct amount of significant figures. Data transformer 360 may keep a record of each transform made to each data and store the record in database 200 so that a record can be kept for data provenance and data auditing use cases. Data transformer 360 may also transform data as necessary prior to storage if the type of database requires a certain data format. Furthermore, data transformer 360 can apply business rules and logic to transform data retrieved from storage prior to sending the data to API manager 110, the transformed data is then ready to integrate easily with the business systems such as, for example, a LOS 116 of a lender 115. In the event of a business rule failure or the occurrence of invalid data, a lender may be able to manually intervene in the process by reviewing the failed rule or invalid data, allowing the lender (or borrower) to correct the data via the website/web app UI, and then updating the LOS or intended recipient platform as necessary. Data acquisition engine 300 can identify, sort, and clean document placeholders. For example, documentation may be placed in a LOS 116 folder system and is then automatically reviewed by platform 100, a correct placeholder is determined, and then it is moved to the appropriate placeholder. In this process the document may be transformed wherein excess and misaligned documentation is removed.

A use case for platform 100 and data acquisition engine 300 may be directed to updating purchase advice information without entering a loan. In this use case, purchase advice data can be uploaded to platform 100 and data is extracted from it. A confidence score may be given to all identified data points, wherein the confidence score indicates an acceptable accuracy score. Data will be cross referenced and standardized with a LOS 116 of record. Once all data has been thoroughly vetted and approved, updates can be loaded into the LOS or accounting platform of the borrower's choice without the need of re-validation.

A use case for platform 100 and data acquisition engine 300 may be directed to borrower identification verification. In this use case, platform 100 verifies that the identification documents are correct and match other data in the LOS 116. If discrepancies are found, platform 100 can alert the user and display the identified issues via UI 130. Once an ID passes all checks, it is placed in the LOS identification placeholder along with a completed customer identification procedure (CIP) form (also referred to as a Patriot Act form). If the ID is incorrect or expired, platform 100 can alert the user and move that document to a miscellaneous placeholder.

Another use case for platform 100 may be directed to homeowner's insurance validation. In this use case, platform 100 validates a homeowner's insurance document is correct and does not have invalid, outdated data. Validation data can include, borrower name, address, start date, policy term, yearly premium, loss payee, replacement cost coverage, and deductible. If there are any discrepancies, platform 100 can alert the user and display the identified issues. If all information is verified correct, then the data can be automatically placed into LOS 116 homeowner's insurance forms. Yet another use case for platform 100 may be directed to income calculation and validation. In this use case, platform 100 directly obtains personal and business tax transcripts along with W-2's for borrowers from the IRS. The borrower's identification is confirmed (e.g., using a digital service such as ID.me). Selected documents may then be sent to the borrower's selected lender's LOS 116 with the income automatically calculated.

Another use case for platform 100 may be directed to automated, personalized generated mortgage loan estimates based at least on user input data and leveraging a generative AI model. In such a use case, a borrower can upload the documents and information he or she has available, and query the generative AI model for a mortgage estimate from one or more potential lenders.

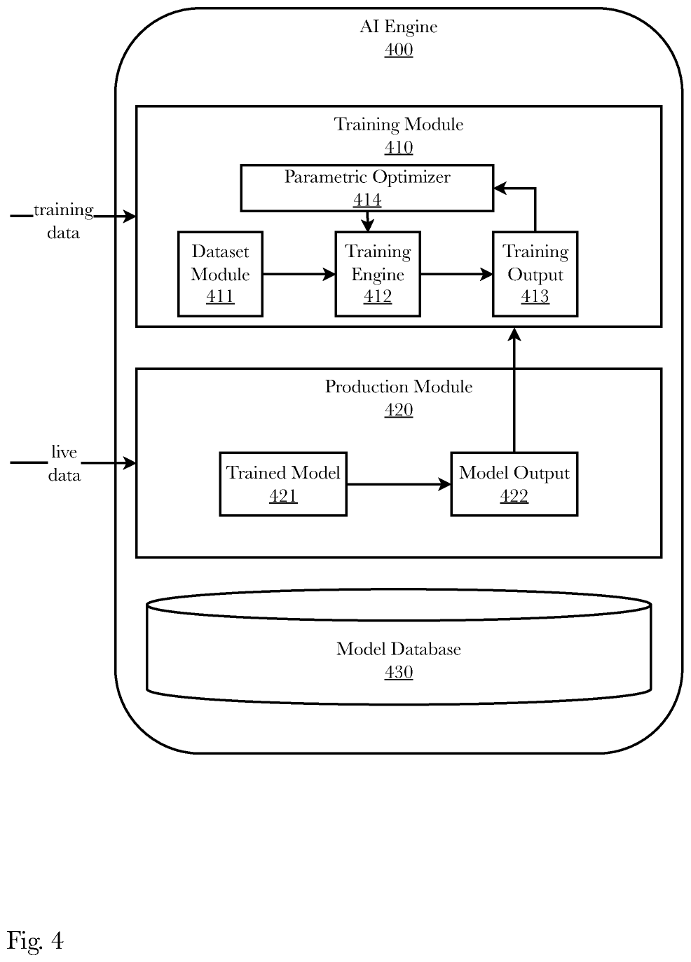

FIG. 4 is a block diagram illustrating an exemplary aspect of a platform for loan origination data validation and predictive analysis, an artificial intelligence engine 400. AI engine 400 is configured to manage the creation, maintenance, and application of one or more machine and/or deep learning models. According to the embodiment, AI engine 400 comprises a training module 410 wherein new models may be trained using various machine and/or deep learning algorithms. A dataset module 411 is configured to receive, retrieve, or otherwise obtain a plurality of data from various sources, pre-process the data to prepare it to be used as input into a training engine 412. Pre-processing data may involve, but is not limited to, formatting the dataset (e.g., CSV, HTML, XLSX, etc.), extract variables (e.g., independent and dependent variables), identifying and handling missing values (e.g., deletion, calculating the mean, etc.), encoding categorical data, splitting the dataset (e.g., split into a training set and test set), feature selection and scaling, data cleaning, data transformation (e.g., normalization, attribute selection, discretization, concept hierarchy generation, etc.), data reduction (e.g., data cube aggregation, attribute subset selection, numerosity reduction, dimensionality reduction, etc.), and/or the like. Dataset module 411 can use data obtained from database 200 and external resources such as third-party services 125. Data from these, and other sources, may be used as training data and dataset module 411 can split this dataset into a training dataset and a test dataset. The training dataset may comprise, for example, 80-90% of the total dataset and the test dataset would comprise the remaining 10-20% of the total dataset. The training dataset may be fed into training engine 412 which uses the training dataset as input into a machine or deep learning algorithm in order to train a model that can be used by platform 100 components to assist borrowers with managing and validating their data. Training engine 412 can allow data scientist and software engineers to train and create models using machine learning techniques by providing them an interface with which to set model parameters such as, for example, error rate, learning rate, weight decay, mini-batch-size, dataset size, epochs, and/or the like.

Training output 413 is produced and can be used as feedback to check the progress of a model in training and make changes to model parameters and hyperparameters via parametric optimizer 414. Parametric optimizer 414 can be configured to apply model tuning via parameter adjustment between model training stages. This represents the iterative training process common when training machine and/or deep learning models, wherein a model is trained using training data, tested using test data, model output analyzed, and model tuning applied until some goal is achieved, usually related to model error rate. Examples of parameters and hyperparameters that may be modified via parametric optimizer 414 can include, but are not limited to, train-test split ratio, learning rate in optimization algorithms, choice of optimization algorithm (e.g., gradient descent, stochastic gradient descent, of Adam optimizer), choice of activation function in a neural network layer (e.g., Sigmoid, ReLU, Tan h, etc.), choice of cost or loss function the model will use, number of hidden layers in a neural network, number of activation units in each layer, the drop-out rate in neural networks, number of epochs, number of clusters in a clustering task, Kernel or filter size in convolutional layers, pooling size, batch, size, the coefficients (or weights) of linear and logistic regression models, weights and biases of a neural network, the cluster centroids in clustering, etc.

A fully trained and tested model is ready to go into production to analyze live data and make predictions. Production module 420 receives a trained model 421 and uses the trained model to make predictions 422 on live data instead of training data. The model output 422 may be used to assist platform components perform various tasks such as classification, validation, and user guidance. For example, a trained model may be a trained classifier network configured to classify input data as one or a plurality of documents associated with the origination of a loan such as a home loan or auto loan. Another example model which may be implemented by platform 100 is a data validation model using a trained regression algorithm to generate a confidence score indicating whether the processed data is valid or not. Yet another model which may be implemented by platform 100 is a generative AI model which can assist platform users (e.g., borrowers and lenders alike) with system onboarding, data collection, query response, recommendations, and/or the like. Another model that may be implemented by platform 100 may be configured to identify potential fair lending risks and/or other biases in the lending process that may adversely affect a borrower.

A model database 430 is present and configured to store information related to the one or more machine and/or deep learning models that may be implemented by trained and managed by AI engine 400. Model database 430 may store current and previous version of production models as well as the training and test datasets associated with each model. Model database 430 may also comprise a record of the transformations applied during data pre-processing to a training dataset.

### Detailed Description of Exemplary Aspects

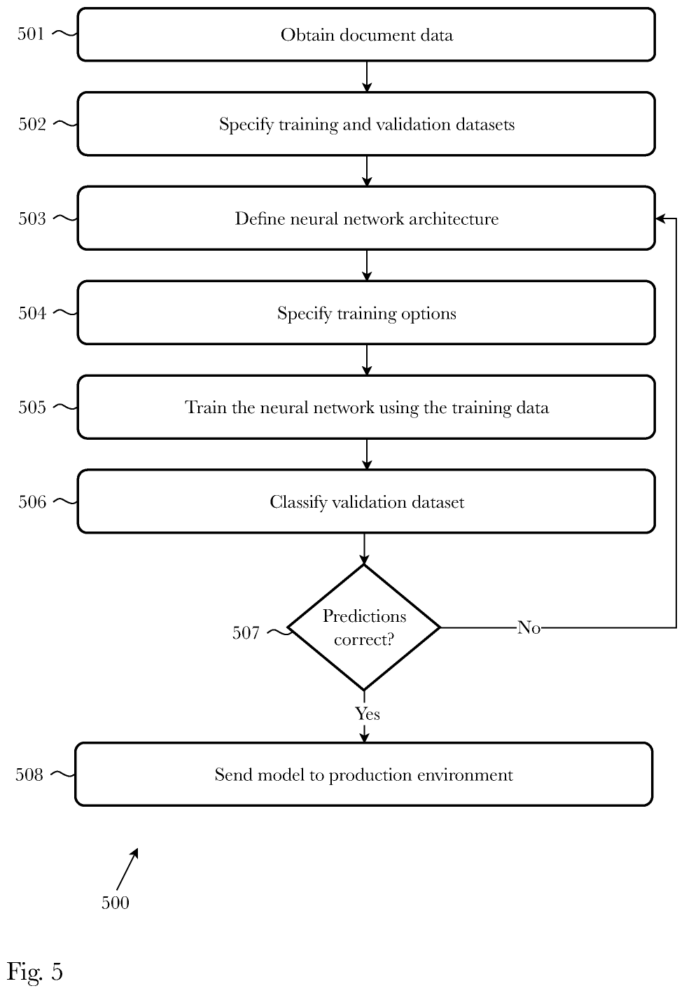

FIG. 5 is a flow diagram illustrating an exemplary method 500 for training a document classifier network, according to an embodiment. According to the embodiment, the process may be conducted by AI engine 400 and begins at step 501 wherein a plurality of document data is obtained. Document data may be obtained from database 200. Document data may be gathered directly from lenders 115 or from data uploaded by borrowers 105. Document data may be labeled data wherein specific documents are given a label that states what type of document it is. For example, pay stub documentation may be labeled “pay stub” and a W-2 may be labeled “W-2”. In some implementations, lenders 115 may upload proprietary documents with appropriate labels and this may be included in the document data. The document data may comprise a large corpus of labeled document data which can be split into a training dataset and a validation (e.g., test) dataset at step 502.

Once the data has been pre-processed and split into training and validation datasets, the next step 503 involves defining the neural network that will be the architecture for the document classifier. For example, if document classifier is based on convolutional neural network (CNNs) architecture, then some exemplary network definitions can include document input layer, convolutional layer, batch normalization layer, ReLU layer, max pooling layer, fully connected layer, softmax layer, and the classification layer. Document input layer is where the document size is specified and is related to the channel size of the network. Convolutional layer defines the filter size, number of filters, and use of padding, if applicable, and can be used to define the stride and learning rates for this layer. Batch normalization layer normalize the activations and gradients propagating through a neural network, making neural network training an easier optimization problem. The use of batch normalization layers between convolutional layers and nonlinearities, such as ReLU layers, can speed up neural network training and reduce the sensitivity to neural network initialization. The ReLU (rectified linear unit) layer is a nonlinear activation function. The fully connected layer comes after the convolutional or down-sampling layers and this layer combines all the features of the previous layers across the document to identify larger patterns. Softmax layer is an activation function that normalizes output of the fully connected layer. The output of the Softmax layer consists of positive numbers that sum to one, which can then be used as classification probabilities by the classification layer.

Once a neural network has been defined, the next step 504 is to select the training options. Training options can include, but are not limited to, number of epochs, initial learning rate, validation data, validation frequency, etc. In some implementations, the document classifier may be trained using stochastic gradient descent with momentum (SGDM) with a low initial learning rate (e.g., 0.01). An epoch is full training cycle on the entire training dataset. During training, the model can be monitored for accuracy by specifying the validation data and validation frequency. In some implementations, the data is shuffled every epoch. At step 505 AI engine 400 trains the neural network using the architecture defined by the above layers, on the training data, and the training options. At step 506 AI engine 400 calculates the accuracy on the validation data at regular intervals during model training. At step 507, if the validation data is producing accurate output, that is, the classifier is correctly classifying validation data, then the document classifier network is ready to be used in a production environment and can be sent to production module 420 at step 508. If instead, the validation dataset does not produce accurate results, then the process may loop back around to step 503, wherein model adjustments can be made to either the training and validation datasets, the defined layers, and/or the training options.

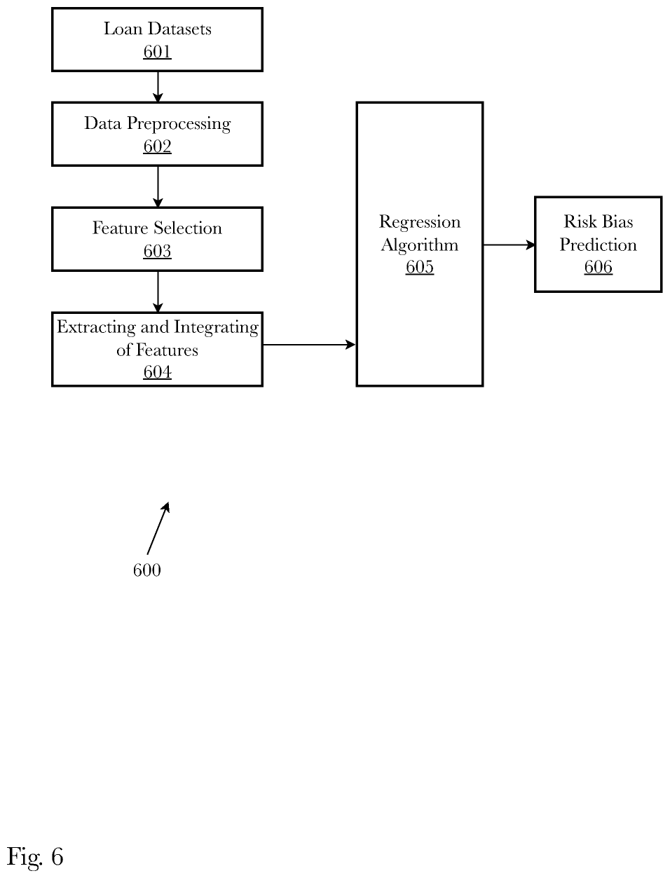

FIG. 6 is a flow diagram illustrating an exemplary method 600 for training a machine learning regression algorithm to make predictions related to risk bias, according to an embodiment. According to the embodiment, the process may be conducted by AI engine 400 and begins at step 601 when platform 100 obtains a loan dataset. According to the embodiment, loan dataset may comprise some, none, or all of the data stored in database 200 as well as data obtained from lenders 115 and third-party services 125. Loan datasets may comprise a plurality of information about a plurality of borrower's and about a plurality of lenders. Borrower data can comprise any information stored in the borrower profile 201 of database 200 such as borrower financial data, demographic data, location data, etc. Loan dataset may comprise historical lending data 204 associated with a lender 115 as well as lender data 205. At step 602 the loan dataset may be preprocessed for input into a machine learning regression algorithm. At a next step 603 feature selection is conducted on the pre-processed loan dataset. Feature selection is the process of identifying and selecting a subset of input variables that are most relevant to the target variable. In some embodiments, feature selection may be performed using techniques known to those skilled in the art such as, for example, correlation statistics or mutual information statistics. Correlation is the measure of how two variables (i.e., features) change together and can be determined using a Gaussian distribution and a linear relationship between variables, according to some implementations. Mutual information feature selection is from the field of information theory and applies information gain to feature selection. Mutual information is calculated between two variables and measures the reduction in uncertainty for one variable given a known value of the other variable. Mutual information is straightforward when considering the distribution of two discrete (categorical or ordinal) variables, such as categorical input and categorical output data (e.g., tax transcript data such as “marital status” and “married” and other categorical input/output pairs).

Next, is step 604 which involves extracting and integrating the selected features. In some implementations, an autoencoder may be utilized to perform feature extraction. An autoencoder is a type of neural network that can be used to learn a compressed representation of raw data. An autoencoder is composed of encoder and decoder sub-models. The encoder compresses the input, and the decoder attempts to recreate the input from the compressed version provided by the encoder. After training, the encoder model is saved, and the decoder is discarded. The encoder can then be used as a data preparation technique to perform feature extraction on raw data that can be used to train a different machine learning model. According to some embodiments, the autoencoder may make use of a self-supervised learning method.

At step 605 the pre-processed data and extracted features may be fed as input into a regression algorithm in order to train a model which can predict risk bias associated with a borrower and a lender, a location, or some other criteria. The type of regression algorithm selected may be dependent upon the embodiment. Exemplary regression algorithms that may be used can include support vector regression, logistic regression, linear regression, ridge regression, neural network regression, lasso regression, decision tree, random forest, KNN model, and/or the like. The model may be trained in a training loop and repeated as necessary until the model provides accurate predictions on a validation dataset. A fully trained model may be deployed into a production environment and fed live data to make risk bias predictions at step 606. Live data may include: borrower information including contact information, demographic information, and financial information; lender data including historical lending data; and applicable third-party data such as, for example, data from governmental or regulatory agencies. Risk bias predictions may be based on a specific lender such that the specific lender's data and a borrower's data may be input into the regression model and a risk bias score may be calculated for the borrower with respect to the lender. For example, the regression model may predict, based on borrower demographics, property locations, historical lender data, and third-party data, that a given lender may have a risk bias which causes the loan term to be different for African-American borrowers than for Caucasian borrowers. Another example may indicate a risk bias is associated with a specific neighborhood if the borrower is a gay person seeking a home loan for a house for sale in the specific neighborhood. The model may indicate via a risk bias score that there is potentially an occurrence of risk bias for a given transaction. A borrower can use this information to advocate for themselves when receiving loan terms from a lender or to use a pre-screening method to filter potential lenders with whom the borrower may choose to apply for a loan with. Governments and regulatory bodies can use the risk bias information to monitor and measure risk bias in lending which can be used to shape policy and rules to benefit groups or individuals that the bias adversely affected. Lenders can use the risk bias information to improve standard and enforce compliance with fair lending laws and other regulations that govern loan origination.

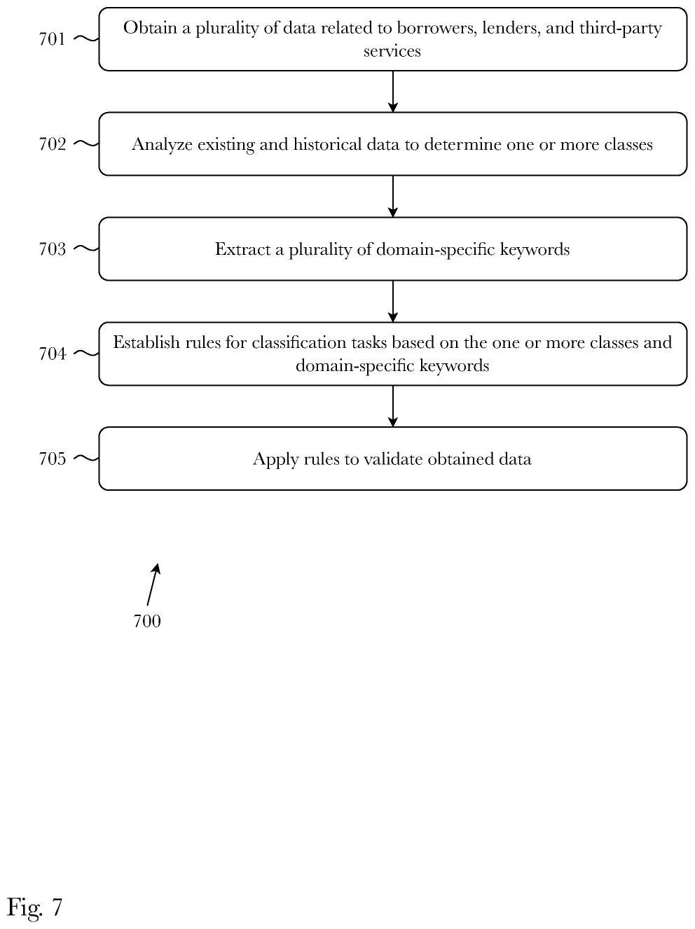

FIG. 7 is a flow diagram illustrating an exemplary process 700 for implementing rules-based text and data validation model, according to an embodiment. According to the embodiment the process begins at step 701 wherein platform obtains a plurality of data related to borrowers, lenders, and third-party services. Examples of obtained data are discussed above, referring to FIG. 2. As a next step 702 the obtained data is analyzed in conjunction with historical data to determine one or more classes associated with text and/or data fields for a given document type. For example, a document type associated with an invoice may have a class data field associated with “invoice” or “payment amount” and/or the like. At the next step 703 a plurality of domain-specific keywords may be extracted from the obtained data. Domain-specific keywords refer to a set of vocabulary of words or phrases used in specialized areas, or domains, that carry specific meaning. For example, AI engine 400 may analyze the obtained data and determine that “credit rating” is a keyword associated with credit report documents based on the amount of times the keyword is encountered during analysis of a plurality of credit report documents. In other implementations, simple if/then code logic may be used to make decisions associated with business rules and logic. At step 704, AI engine 400 may establish rules for classification and data validation tasks based on the one or more classes and domain-specific keywords. As a final step 705, the established rules are applied to extracted data fields in order to validate obtained data.

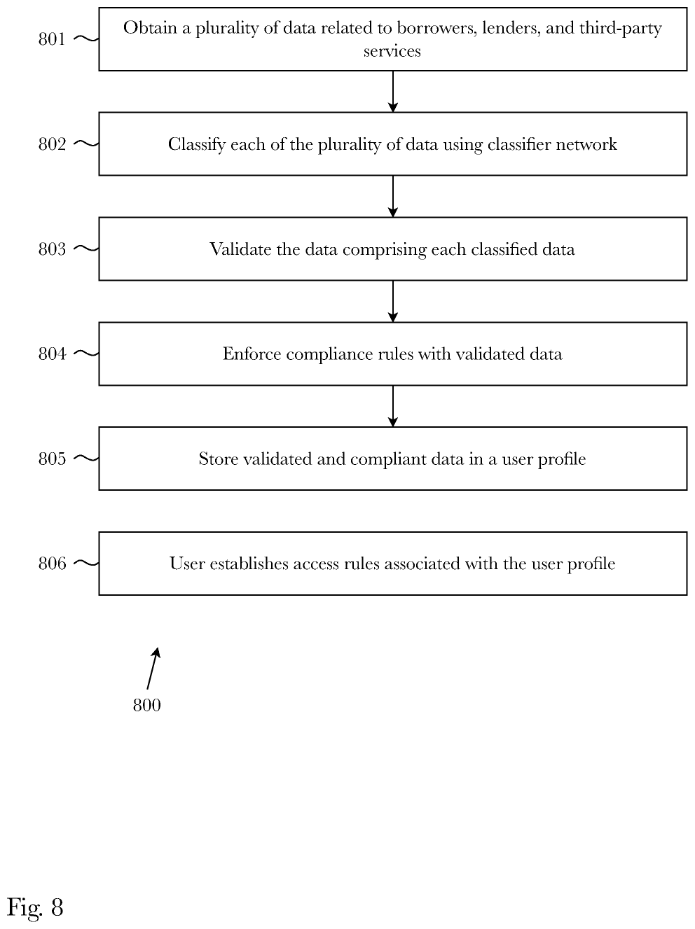

FIG. 8 is a flow diagram illustrating an exemplary method 800 for processing uploaded data into user profiles, according to one aspect. According to the aspect, the process begins at step 801 when data acquisition engine 300 obtains a plurality of data related to borrowers, lenders, and/or third party services. The obtained data may pre-processed and/or encrypted, dependent upon the embodiment, prior to being used as input into a classifier network configured to classify received data as a type of document associated with loan origination at step 802. Once a classification label has been accurately applied to an obtained document, data acquisition engine 300 may perform data validation actions using a trained machine and/or deep learning model at step 803. At step 804 compliance rules and regulations may be retrieved and applied to enforce data compliance on the validated data. At step 805, the validated and compliant data may be stored in a user profile. The user profile may be associated with a borrower, a lender, and/or in some instances, a third-party service. As a last optional step 806, the user (e.g., borrower or lender) can establish access rules associated with the user profile. For example, a borrower can provide data access authorization to certain lenders, wherein the borrower's data can be integrated with those lenders' LOS. For instance, a borrower could set authentication rules for access to the user profile.

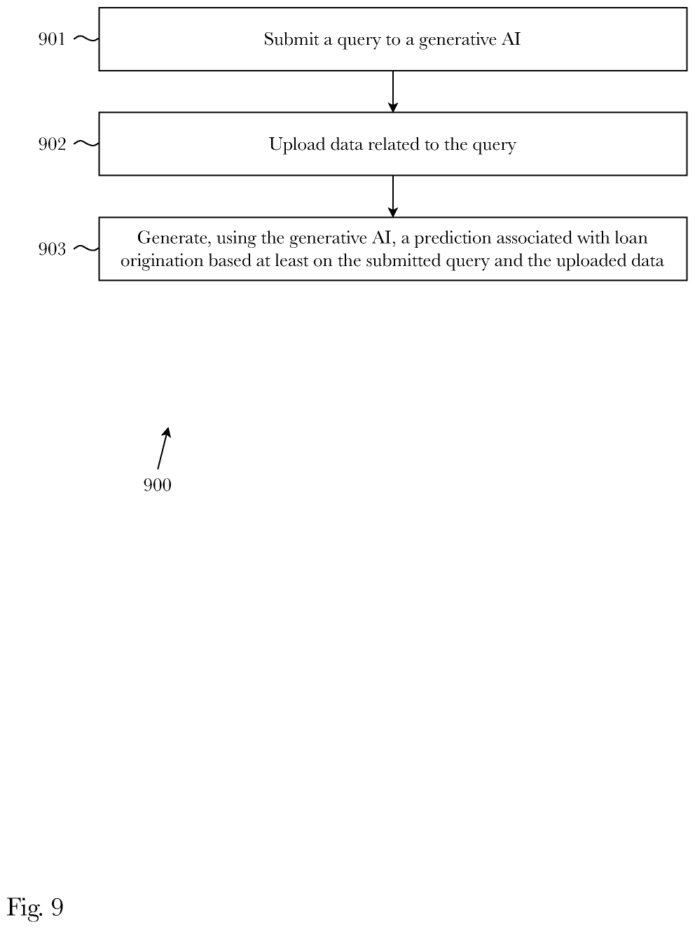

FIG. 9 is a flow diagram illustrating an exemplary method 900 for generating prediction associated with loan origination utilizing generative AI, according to one aspect. A data analytics engine 140 may leverage a trained generative AI model to facilitate user interaction such as receiving various user queries associated with the loan origination process and mortgages in general. The process begins at step 901 when a user submits a query to a generative AI model implemented by platform 100. The user may access the generative AI via UI 130 which may provide, for example, a chat box or similar mechanism which allows the user to type (or in some instances with speech to text capabilities, speak) a query which may be provided to the generative AI as an input. The generative AI may respond by requesting that the user provide documentation or other information related to the query or by requesting the user provide specific documentation and/or information. At step 902 the user can upload the data related to the query via UI 130. At step 903, the generative AI generates a prediction associated with loan origination based at least on the submitted query and the uploaded data in response to the user query.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

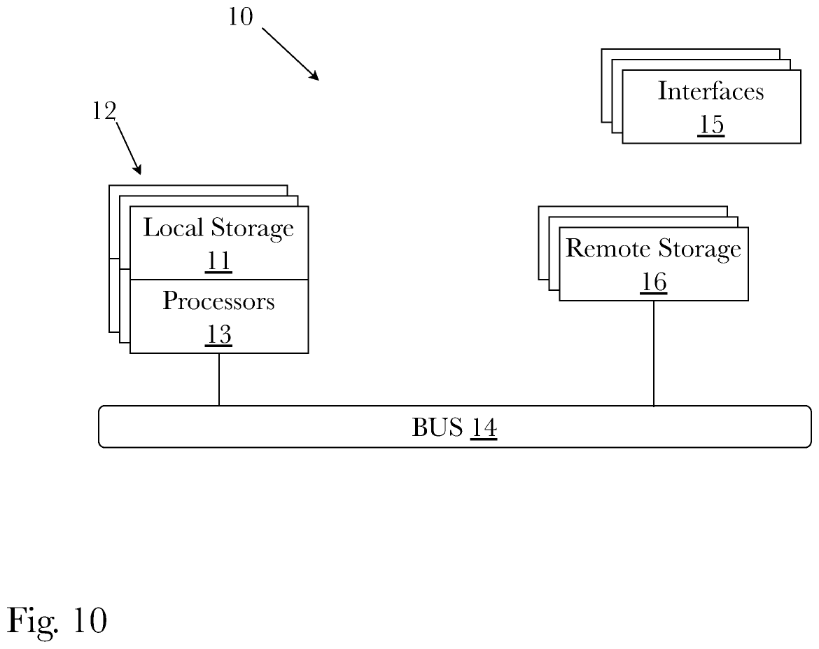

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

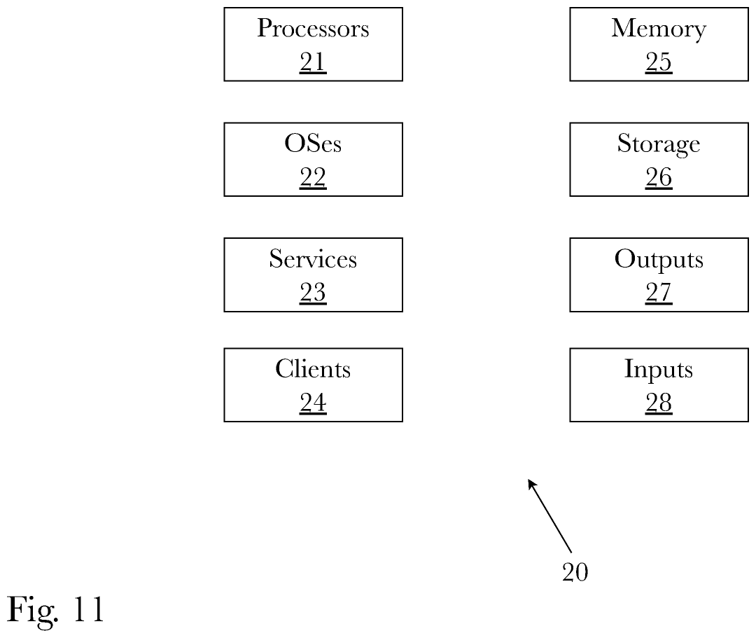

In some aspects, systems may be implemented on a standalone computing system. Referring now to FIG. 11, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

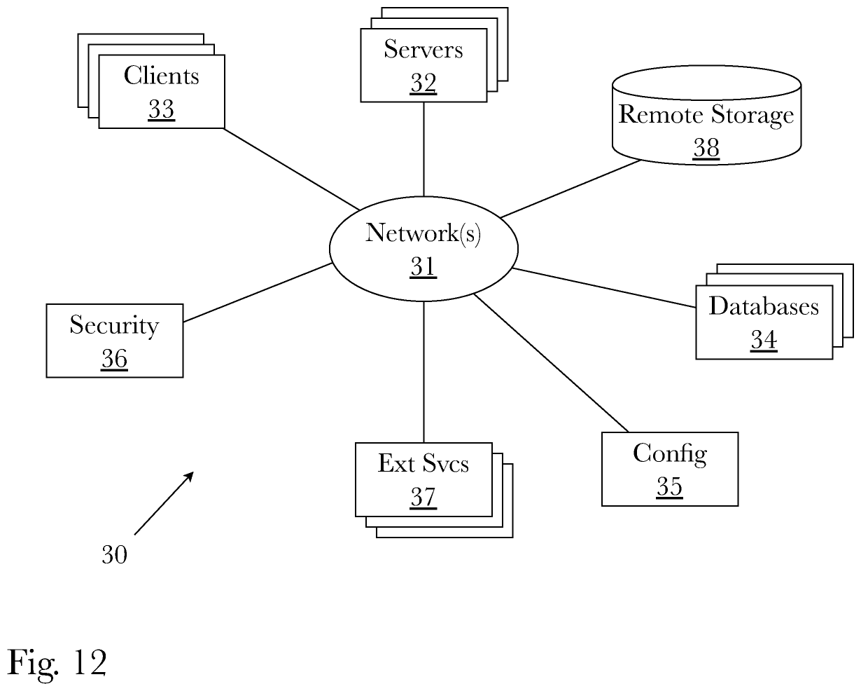

In some aspects, systems may be implemented on a distributed computing network, such as one having any number of clients and/or servers. Referring now to FIG. 12, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 11. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols. Additionally, new and not yet existing network protocols may be used, if applicable, in various embodiments of the disclosed system.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Additionally, or alternatively, platform and systems described herein may utilize one or more binary large object (BLOB) as data storage mechanisms. A binary large object is a collection of binary data stored in single entity, which is a file-like object of immutable, raw data; they can be read as text or binary data, or converted into a readable stream so it can be used for data processing tasks.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

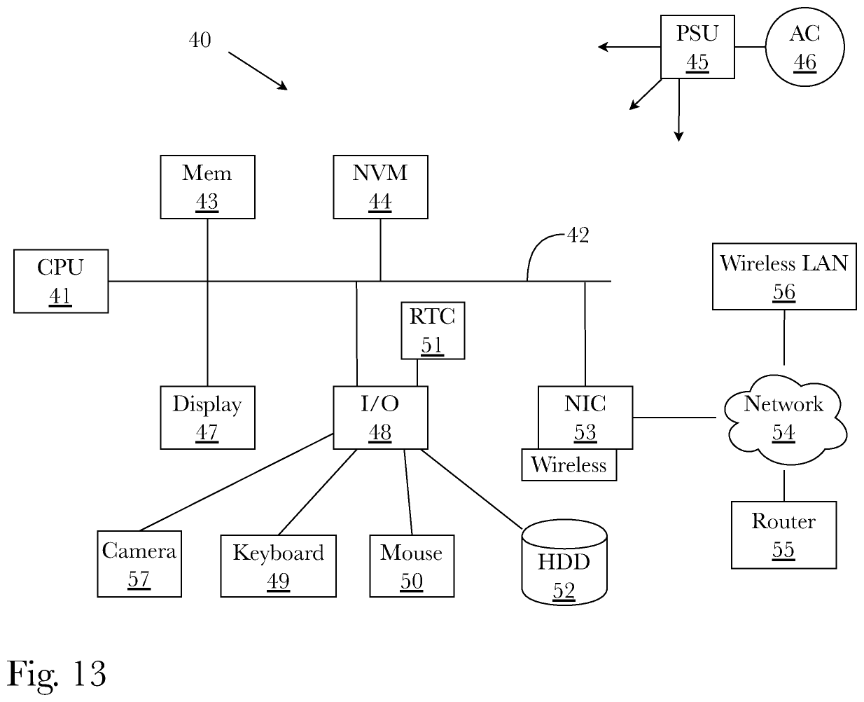

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

1. A system for loan origination data validation and predictive analysis, comprising:
a computing device comprising a memory and a processor;
a data acquisition engine comprising a first plurality of programming instructions stored in the memory which, when operating on the processor, causes the computing device to:
receive one or more documents associated with a borrower;
feed the one or more documents into a first machine learning model configured to assign a classification to each of the one or more documents;
feed each of the one or more documents and its classification into a second machine learning model configured to validate the data; and
store the validated data in a borrower profile; and
a generative artificial intelligence model configured to receive as input query and the borrower profile and to generate predictive responses to the query.

2. The system of claim 1, wherein the first machine learning model is a trained classifier network.

3. The system of claim 1, wherein the second machine learning model is trained using a regression algorithm.

4. The system of claim 1, wherein the data acquisition engine is further configured to:
retrieve one or more compliance rules; and
transform the validated data to enforce compliance with the one or more compliance rules.

5. The system of claim 1, wherein the borrower profile comprise one or more access rules define one or more lender institutions which the borrower has authorized to the data in the borrower profile.

6. The system of claim 5, further comprising an application programming interface comprising a second plurality of programming instructions stored in the memory which, when operating on the processor, causes the computing device to:
transmit the validated data in the borrower profile to a loan origination system associated with the one or more authorized lender institutions.

7. A method for loan origination data validation and predictive analysis, comprising the steps of:
receiving one or more documents associated with a borrower;
feeding the one or more documents into a first machine learning model configured to assign a classification to each of the one or more documents;
feeding each of the one or more documents and its classification into a second machine learning model configured to validate the data;
storing the validated data in a borrower profile; and
using a generative artificial intelligence model configured to receive as input query and the borrower profile to generate predictive responses to the query.

8. The method of claim 7, wherein the first machine learning model is a trained classifier network.

9. The method of claim 7, wherein the second machine learning model is trained using a regression algorithm.

10. The method of claim 7, wherein the data acquisition engine is further configured to:
retrieve one or more compliance rules; and
transform the validated data to enforce compliance with the one or more compliance rules.

11. The method of claim 7, wherein the borrower profile comprise one or more access rules define one or more lender institutions which the borrower has authorized to the data in the borrower profile.

12. The method of claim 11, further comprising the steps of:
using an application programming interface to transmit the validated data in the borrower profile to a loan origination system associated with one or more authorized lender institutions.
